(19) United States
(12) Patent Application Publication
(10) Pub. No.: US 2004/0089398 A1
(43) Pub. Date: May 13, 2004

(54) Splice for a heat shrinkable label

(75) Inventors: Doug Ulbrich, Edison, NJ (US); Thomas Eric Johnson, Clover, SC (US)

Correspondence Address: Thomas J. Durling, Esq., Drinker Biddle & Reath LLP, One Logan Square, 18th and Cherry Sts., Philadelphia, PA, 19103-6996, US

(73) Assignee: Sonoco Development, Inc.

(21) Appl. No.: 10/704,059

(22) Filed: Nov. 7, 2003

Related U.S. Application Data
(62) Division of application No. 10/075,547, filed on Feb. 14, 2002.
Application No. 10/075,547 is a continuation of application No. 09/064,658, filed on Apr. 23, 1998, now abandoned.

(51) Int. Cl. B32B 31/00

(52) U.S. Cl. 156/86; 156/157

(57) ABSTRACT

A method of labeling a product container includes the steps of providing first and second webs of heat shrinkable label material and a heat shrinkable splice tape having an adhesive on a surface of the tape. The webs are arranged such that ends of the webs abut one another and the splice tape is adhered to a portion of each of the webs to extend transversely across a width defined by the webs to form a continuous web. The webs may include separate laminates of heat shrinkable material and ink. The webs have a combined length sufficient to encircle an outer surface of a container and shrink into a substantially conforming relationship thereto when the webs are heated.

### CROSS-REFERENCE TO RELATED APPLICATIONS

This is a divisional of co-pending application Ser. No. 10/075,547, filed Feb. 14, 2002, which is a continuation of Ser. No. 09/064,658, filed Apr. 23, 1998, now abandoned.

### FIELD OF THE INVENTION

The present invention relates to labeling and more particularly to heat shrinkable labeling used for product containers.

### BACKGROUND OF THE INVENTION

Heat shrinkable labels are commonly used for packaging and containers, e.g., soda bottles and other round containers. The labels are typically printed end to end on an elongated web which is wound on a roll or spool. One edge of the web is first glued on to the side wall of the container and then the label is wrapped around the circumference of the container. The label is then cut from the roll and the resulting edge is glued on to the container such that the two edges overlap. A sufficient amount of slack is provided in the label to accommodate the heat shrink qualities of the material. When heat is applied, the label material shrinks and conforms to the surface contours of the container. An example of such a labeling operation is identified in Hoffmann U.S. Pat. No. 4,406,721, which is herein incorporated by reference.

It is desirable to operate the labeling machine on a continuous basis. For this reason, a new supply of labels must be presented after the end of each roll. Typically, the end of one roll of labels is automatically spliced to the beginning of a second or following roll, creating a continuous web.

In the past, the splice material has been applied to the outside of the label web, over the printing on the label. The splice is brightly colored so as to stand out on the container as it is conveyed towards the final packaging equipment. A quality control person is required to monitor the labeled containers to visually locate containers that include a spliced label and remove those containers from the line prior to packaging and shipment to a customer. The splices have to be placed on the outside of the label so that the quality control person can see the splice on the label. If the splice were placed under the label, the coloring of the label could obscure the splice, resulting in a spliced label being shipped.

Since the labeled containers are usually fed on a conveyor to a packaging location, there is sometimes a tendency for the product to turn or spin around on the conveyor such that the splice is not facing the quality control person as the container passes. In these situations, a container with a spliced label may be missed and the container shipped to a customer. For this purpose, a fallout flag is often attached to the label at the splice so that the container having the splice is more easily identifiable for removal purposes. Even with this added precaution, containers with spliced labels are shipped much of the time.

The prior spliced labels are considered unacceptable for most applications because the labels tend to cover a portion of the text or marketing materials on the label. The splices also disfigure the label due to the contrasting brightly colored splice. Moreover, conventional splices are typically made from materials which are non-shrinkable. As such, when the spliced label is heat-shrunk onto a container, the splice distorts the label.

### SUMMARY OF THE INVENTION

According to the present invention, there is provided a method of labeling a product container. The method includes the step of providing first and second elongated webs of heat shrinkable label material. Each of the first and second webs includes opposite sides defining a width, a leading end and an opposite trailing end. A heat shrinkable splice tape is also provided having an adhesive on a surface thereof.

The method also includes the step of aligning the trailing end of the first web with the leading end of the second web such that the ends abut one another. The splice tape is adhered to a portion of the first web adjacent its trailing end and to a portion of the second web adjacent its leading end. The splice tape is adhered to the first and second webs such that it extends transversely thereto across a majority of the width defined by the webs so as to form a continuous web.

The webs may include a first laminate of heat shrinkable material having an adhesive in contact therewith and ink contacting the adhesive. The webs may also include a second laminate of heat shrinkable material contacting the ink.

According to one embodiment of the method, the first and second webs have a combined length sufficient to encircle an outer surface defined by a container. End portions of the first and second webs are adhered to each other to secure the webs in a closed loop encircling the container. The webs and splice tape are heated to shrink them into a substantially conforming relationship with the outer surface defined by the container.

According to one embodiment, the splice tape is located within an interior of the closed loop defined by the webs. According to an alternative embodiment, the web is located on an exterior surface of the webs and comprises transparent material.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 is an isometric view of a container with a label surrounding the perimeter of the container, the label including a heat shrinkable splice as contemplated by the present invention.

FIG. 2 is an isometric view of abutting ends of two label rolls connected by the shrinkable splice of the present invention.

FIG. 3 is a partial cross sectional view of a container having the heat shrinkable label and splice combination as contemplated by the present invention and as taken along line 3-3 in FIG. 1.

FIG. 4 is a partial cross sectional view of the container, heat shrinkable label and splice combination as taken along line 4-4 in FIG. 1.

### DETAILED DESCRIPTION OF THE DRAWINGS

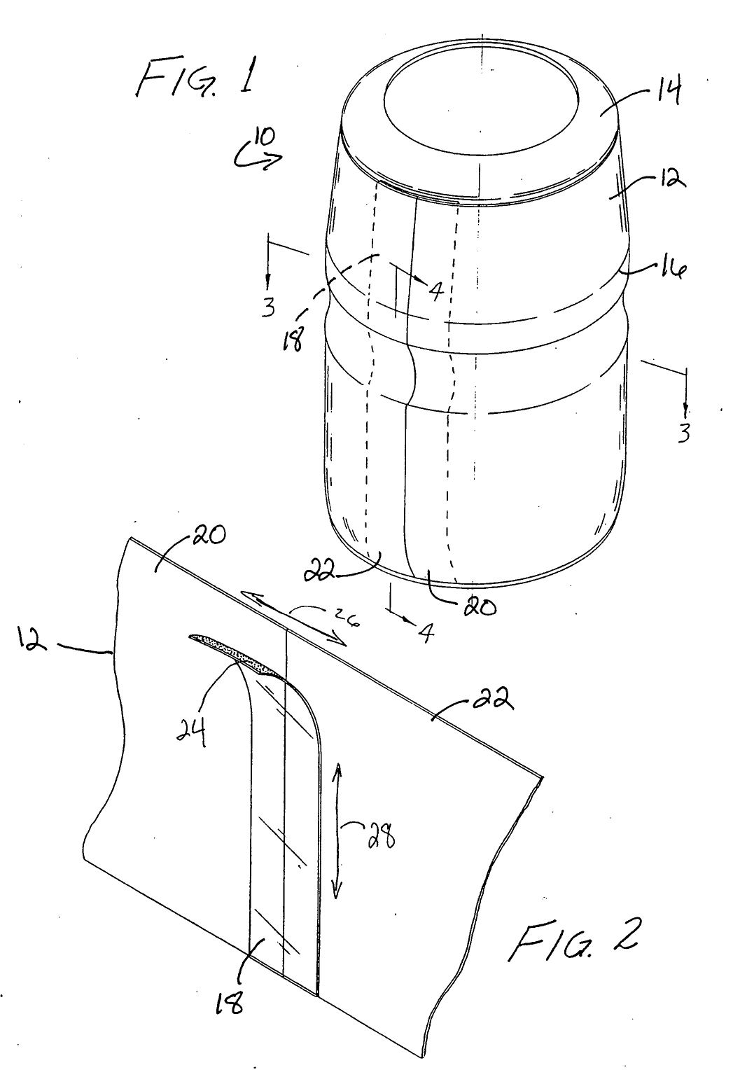

In the drawings, where like numerals identify like elements, there is shown a container which is generally referred to by the numeral 10. In FIG. 1, the container 10 is a generally cylindrical can which is contemplated to have a removable lid or cap. The container 10 has a heat shrunk label 12 thereon. The label 12 is formed such that the edge 14 wraps over the top edge of the container 10. In addition, a series of perforations 16 are provided such that the top portion of the label 12 may be separated from the bottom portion when the lid of the container 10 is unscrewed from the base of the container. As illustrated in phantom in FIG. 1, a splice 18 is provided under the label for joining two ends 20, 22 of label material.

The formation of the splice 18 is more particularly illustrated in FIG. 2. The edges of the two ends 20, 22 of label material are positioned in an abutting relationship. Alternatively, there may be some overlap and the edges may be tacked or glued to one another. The splice 18 is positioned over the joint between the two ends of materials 20, 22 and is secured thereto by an adhesive 24 which is preferably formed on the rear surface of the splice material. The splice 18 secures the two ends 20, 22 of the label material and permits the attachment of the label material to the container in the manner described above.

After the label 12 is heat shrunk onto the container 10, the splice 18 is located inside of the label, underneath the ends 20, 22 of the abutting edges of the two rolls of material. Alternatively, the splice could be positioned over the printing (not shown) on the label 12 and, when the label material is wrapped around the container, positioned on the outside of the label. For this reason, the splice material is preferably clear or transparent so that the printing is not obliterated. A transparent splice also matches transparent labels, whether on the inside of the outside of the butt joint.

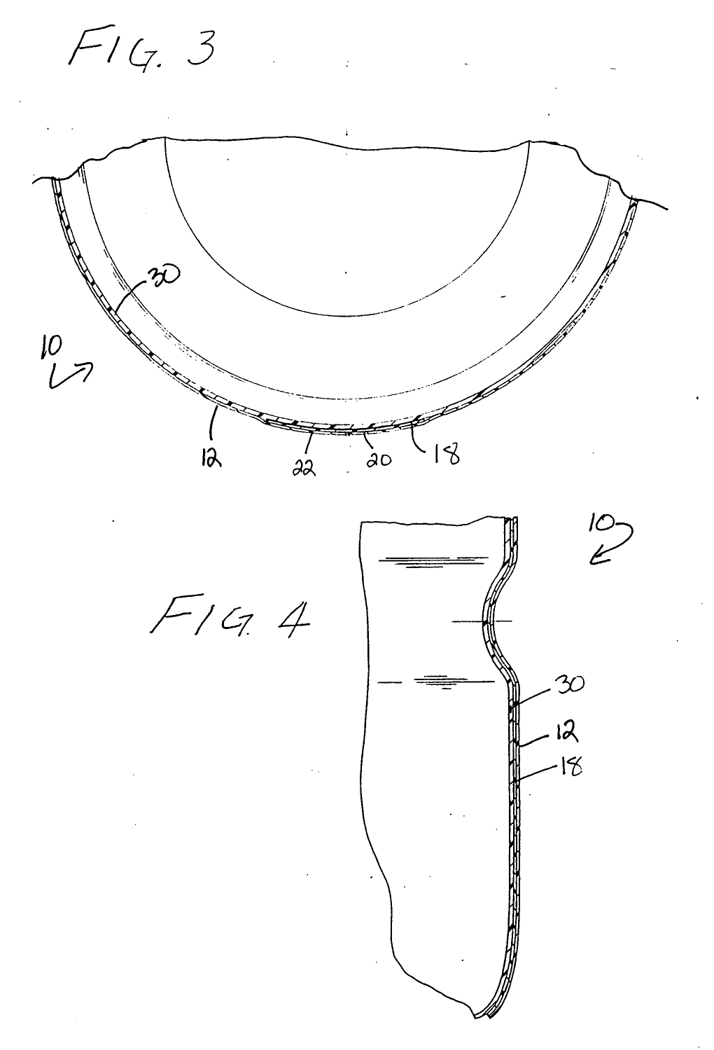

Another aspect of the invention is the use of a heat shrinkable material for the splice 18. This material will preferably have shrink characteristics that are similar (if not exact) to that of the label material. This shrink rate is preferably compatible in both the longitudinal and lateral directions of the label material. A typical label material will be bidirectional in that it will have a greater shrink rate in the longitudinal direction (see arrow 26 in FIG. 2) than in the lateral direction (arrow 28 in FIG. 2). The splice will be formed such that it is positioned transverse to the label. The longitudinal or lengthwise shrink rate of the splice will be preferably the same or similar to that of the lateral (28) shrink rate of the label material. Similarly, the shrink rate of the splice in its lateral or width-wise direction will be similar to that in the longitudinal (26) direction of the label. These properties for the splice will create relatively even shrinkage of the label when the heat is applied, and thus limit or prevent distortion of the printing on the label and/or tearing, splitting or fatiguing due to irregular shrinkage of the two materials. As can be seen in FIGS. 3 and 4, the label 12 and the splice 18 conform to the contours of the sidewall 30 of the container 10. Because the splice also shrinks with the label, the conformance is relatively the same at the splice as it would be where the label material alone covers the contour.

Another contemplated feature of the present invention is the adhesive used in conjunction with the splice as well as the tear strength of the splice material. Typically, the splice is formed on a roll with adhesive on one surface thereof and a release liner covering the adhesive. In order for the operation of the label machine to be substantially continuous, the splice must be created quickly. This requires the splice material to be unrolled from the roll, removed from the release liner, and adhered to the abutting edges of the label material at a relatively high rate of speed. Sufficient tensile strength must be provided in the lengthwise direction of the splice material. Also, the adhesive must have sufficient release qualities to permit this removal from the roll without undue resistance.

The splice material and adhesive must have sufficient strength to secure the two ends of the label material together as it is pulled into the labeling machine and as it is applied to the container. Also, the adhesive must be able to withstand the heat applied to the label and splice during shrinking of the label onto the container. If the adhesive were to degrade excessively under heat or tension, the splice could become undone. Further, the adhesive must allow the splice and label to shrink. It is contemplated that the relative rate of shrinkage may not be the same (i.e., one may shrink at a greater rate), although the overall shrinkage percentage may be compatible in the final condition (i.e., when the two reach final condition, they have shrunk relatively the same amount).

With these parameters in mind, certain materials have been identified to create the combined heat shrinkable label and splice as contemplated by the present invention. The label material may be a shrinkable polypropylene film such as Vision® 370C or 345C from AET Packaging Film of Wilmington, Del. Alternatively, the label may be made from a laminate of the 370C film in conjunction with a Vision® 370W type film with a two part urethane coating. Other commercial shrinkable labels or materials are also known and may be utilized for the present invention.

The material of the splice is preferably a clear, flexible, high shrinkage film with an aggressive adhesive coating. The aggressive adhesive is preferably selected to have a high range of tack (based on testing according to ASTM D 2979-71) between about 300 gm/cm2 and about 600 gm/cm2. Preferably, the aggressive adhesive has a tack of about 450 gm/cm2. A top coat on the film layer may be included if the splice is to have printing or coloring disposed on it.

One suitable splice material that is available on the market is SECUREcal™ EXPE-400-FC Shrink which is manufactured by the Flexcon Company, Inc. This material includes a polyethylene film layer with a TC-391 top coating, a V-23 adhesive and is provided on a 44 PP-8 poly coated natural kraft release liner. The V-23 adhesive is a permanent pressure sensitive acrylic adhesive with a tack within the above preferred ranges. The adhesive layer is about 1.0 to 1.1 mils thick. The film layer is approximately 4 mils thick. The liner is about 3.1 mils thick. This material has the desired relative shrink ratios and has been found through testing to be compatible with the label materials identified above, and for this reason is presently preferred. The adhesive is capable of withstanding the stresses exerted on the adhesive by the heat shrinking of the abutted labels. The adhesive also resists degradation.

An another splice material which can be used in the present invention is SECUREcal™ DEV-200-C Shrink which is also manufactured by the Flexcon Company, Inc. This splice material includes a clear vinyl film layer with a TC-248 top coating, a V-23 adhesive and a 44 PP-8 poly coated natural Kraft release liner. The adhesive layer is about 1.0 to 1.1 mils thick. The film layer is approximately 2 mils thick. The liner is about 3.1 mils thick.

Based on the teachings provided herein, persons skilled in the art would be readily capable of substituting other types of splice material for the above preferred materials.

While the present invention has been described as applicable for splicing two rolls of label material together, it is also contemplated that the present invention can be used to attach multiple webs of label material together to form a single roll. In this embodiment, the present invention would be used by a label manufacturer to splice a series of webs of label material together. The spliced label material would then be wound onto a roll for subsequent use in a labeling machine.

As with conventional splices for attaching multiple rolls in labeling machines, conventional splices for attaching multiple webs on a single roll must be brightly colored. The bright coloring of the conventional splice permits the splice to be visually detected so that the splice can be skipped prior to application to a product, or a product which contains the splice can be removed by the operator prior to shipment. The present invention addresses this problem with conventional systems by using a transparent heat-shrinkable splice to form a roll of continuous label material from a series of shorter label webs.

The present invention solves the problems of the prior art systems by eliminating the need to detect splices within a label. As a result, the present invention greatly increases the production efficiency of a labeling process.

The present invention may be embodied in other specific forms without departing from spirit or essential attributes thereof and, accordingly, reference should be made to the appended claims, rather than to the foregoing specification, as indicating the scope of the invention.

What is claimed is:

1. A method of labeling a product container comprising the steps of:
providing first and second elongated webs of heat shrinkable label material each having opposite sides defining a width, a leading end and an opposite trailing end;
providing a heat shrinkable splice tape including an adhesive on a surface defined by the splice tape;
aligning the trailing end of the first web with the leading end of the second web such that the ends abut one another;
adhering the splice tape to a portion of the first web adjacent the trailing end and to a portion of the second web adjacent the leading end to extend transversely to the webs across a majority of the width defined by the webs so as to form a continuous web.

2. The method according to claim 1, wherein the splice tape is transparent.

3. The method according to claim 1, wherein each of the provided webs comprises:
a first laminate of heat shrinkable material;
an adhesive in contact with the first laminate;
ink in contact with the adhesive; and
a second laminate of heat shrinkable material in contact with said ink, the first and second laminates having substantially equivalent shrinkage characteristics.

4. The method according to claim 3, wherein the splice tape and each of the laminates of the webs has bidirectional shrinkage characteristics selected to provide longitudinal and lateral shrinkage percentages for the splice tape that are substantially equal to respective lateral and longitudinal shrinkage percentages for the webs.

5. The method according to claim 1 wherein each web is provided on a separate roll.

6. The method according to claim 1 further comprising the step of winding the continuous web onto a roll.

7. A method of labeling a product container comprising the steps of:
providing a container defining an outer surface;
providing first and second web segments of heat shrinkable material, each web segment having opposite first and second end edges defining a length therebetween, the lengths of the first and second segments having a combined length sufficient to encircle the outer surface defined by the container;
providing a splice tape including a heat shrinkable portion defining a surface, the splice tape including a coating of an adhesive on the surface of the heat shrinkable portion;
aligning the first and second web segments such that the second end edge of the first web segment is juxtaposed to and aligned with the first end edge of the second web segment;
applying the splice tape to the first and second web segments such that the splice tape overlaps a portion of each of the first and second web segments adjacent the aligned end edges, the adhesive coating of the splice tape securing the splice tape to the first and second web segments to form a single continuous web;
forming the first and second web segments into a substantially closed loop encircling the outer surface of the container;
adhering a portion of the first web segment adjacent its first end edge to a portion of the second web segment adjacent its second end edge to secure the first and web segments in the form of a closed loop; and
heating the first and second web segments and the splice tape sufficiently to shrink the web segments and splice tape into a substantially conforming relationship with the outer surface defined by the container.

8. The method according to claim 7, wherein the step of forming the first and second web segments into a substantially closed loop results in the splice tape being located within an interior defined by the substantially closed loop.

9. The method according to claim 8, wherein the step of forming the first and second web segments into a substantially closed loop results in the splice tape being located on an exterior surface defined by the first and second webs.

10. The method according to claim 9, wherein the splice tape comprises transparent material.

11. The method according to claim 7, wherein the first and second web segments are provided from first and second web rolls.
